(19) United States
(12) Patent Application Publication
(10) Pub. No.: US 2011/0159278 A1
(43) Pub. Date: Jun. 30, 2011

(54) HARD COATING COMPOSITION AND LAMINATE INCLUDING A HARD COATING LAYER

(76) Inventors: Dae Kyu Lee, Uiwang-si (KR); Kyoung Ku Kang, Uiwang-si (KR)

(21) Appl. No.: 12/982,284

(22) Filed: Dec. 30, 2010

(30) Foreign Application Priority Data
Dec. 31, 2009 (KR) 10-2009-0135677

(51) Int. Cl. B32B 5/00; C09D 135/02; C08K 5/05; C08K 5/101; B32B 27/08

(52) U.S. Cl. 428/336; 524/854; 524/765; 524/773; 428/515; 428/335

(57) ABSTRACT

A hard coating composition and a laminate including a hard coating layer, the hard coating composition including an alkylene glycol acrylic monomer; a polyfunctional acrylic monomer; and a polymerization initiator, wherein the alkylene glycol acrylic monomer is present in an amount of about 5% to about 69% by weight, based on a total solids content of the composition.

### 1. FIELD

Embodiments relate to a hard coating composition and a laminate including a hard coating layer.

### 2. DESCRIPTION OF THE RELATED ART

Plastics may be used in the manufacture of, e.g., construction materials, automotive exterior parts, paper, lumber, furniture, soundproofing walls, optical materials, cosmetic containers, and various display devices. For the purpose of protecting such plastics, functional hard coatings may be widely applied to plastic products.

With a recent trend toward development of various displays, e.g., LCDs, PDPs, and projection TVs, there has been a greatly increased demand for functional hard coatings that cover surfaces of plastic sheets in windows of a variety of household electronic appliances and mobile phones including the displays in order to protect the displays from damage, e.g., scratches.

Under these circumstances, a great deal of research has been conducted into all aspects on techniques for the formation of, e.g., transparent, impact resistant, flexible, solvent resistant, and/or scratch resistant hard coat layers on surfaces of plastic sheets in windows.

### SUMMARY

Embodiments are directed to a hard coating composition and a laminate including a hard coating layer.

At least one of the above and other features and advantages may be realized by providing a hard coating composition including an alkylene glycol acrylic monomer; a polyfunctional acrylic monomer; and a polymerization initiator, wherein the alkylene glycol acrylic monomer is present in an amount of about 5% to about 69% by weight, based on a total solids content of the hard coating composition.

The alkylene glycol acrylic monomer may include from 1 to about 35 alkylene glycol moieties.

The alkylene glycol acrylic monomer may include one or more compounds represented by Formula 1, below:

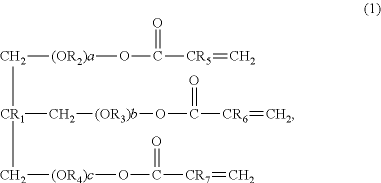

and

in Formula 1 R₁ may be hydrogen, C₁-C₅ alkyl, or —CH₂(OR′₁)OC(═O)CR₈═CH₂, R₂, R₃, R₄, and R′₁ may each independently be —CH₂CH₂—, —CH₂CH₂CH₂—, —CH(CH₃)CH₂—, or —CH₂CH₂CH₂CH₂—, R₅, R₆, R₇, and R₈ may each independently be H or —CH₃, and a, b, and c may each independently be 0 or positive integers, the sum of a, b, and c being 1 to about 35.

R₂, R₃, R₄, and R′₁ may each be —CH₂CH₂—.

The polyfunctional acrylic monomer may include at least one of dipentaerythritol hexaacrylate (DPHA), pentaerythritol triacrylate (PETA), tris(2-hydroxyethyl)isocyanurate triacrylate (THEIC), trimethylol propane triacrylate (TMPTA), hexanediol diacrylate (HDDA), dicyclodecanedimethanol diacrylate (DCPA), and mixtures thereof.

The polymerization initiator may include at least one of 1-hydroxycyclohexyl phenyl ketone, α,α-dimethoxy-α-hydroxyacetophenone, a blend of 1-hydroxy-cyclohexyl-phenyl ketone and benzophenone, 2-hydroxy-2-methyl-1-phenylpropane, and mixtures thereof.

The hard coating composition may further include an organic solvent including at least one of alcohol and acetate.

The alkylene glycol acrylic monomer and the polyfunctional acrylic monomer may be present in a total amount of about 90% to about 99.9% by weight, based on the total solids content of the hard coating composition, and the polymerization initiator may be present in an amount of about 0.1% to about 10% by weight, based on the total solids content of the hard coating composition.

The hard coating composition may further include a leveling agent, the leveling agent being included in an amount of about 0.01% to about 10% by weight, based on a total weight of the hard coating composition.

At least one of the above and other features and advantages may also be realized by providing a laminate including a substrate; and a hard coating layer on the substrate, the hard coating layer being formed from the hard coating composition of an embodiment.

The substrate may be a PMMA sheet including rubber particles dispersed therein.

The hard coating composition may be coated to a thickness of about 1 μm to about 40 μm.

The alkylene glycol acrylic monomer of the hard coating composition may include from 1 to about 35 alkylene glycol moieties.

The alkylene glycol acrylic monomer may include one or more compounds represented by Formula 1, below:

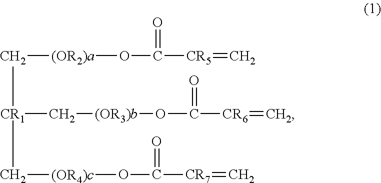

and

in Formula 1 R₁ may be hydrogen, C₁-C₅ alkyl, or —CH₂(OR′₁)OC(═O)CR₈═CH₂, R₂, R₃, R₄, and R′₁ may each independently be —CH₂CH₂—, —CH₂CH₂CH₂—, —CH(CH₃)CH₂—, or —CH₂CH₂CH₂CH₂—, R₅, R₆, R₇, and R₈ may each independently be H or —CH₃, and a, b, and c may each independently be 0 or positive integers, the sum of a, b, and c being 1 to about 35.

R₂, R₃, R₄, and R′₁ may each be —CH₂CH₂—.

The polyfunctional acrylic monomer of the hard coating composition may include at least one of dipentaerythritol hexaacrylate (DPHA), pentaerythritol triacrylate (PETA), tris(2-hydroxyethyl)isocyanurate triacrylate (THEIC), trimethylol propane triacrylate (TMPTA), hexanediol diacrylate (HDDA), dicyclodecanedimethanol diacrylate (DCPA), and mixtures thereof.

The polymerization initiator of the hard coating composition may include at least one of 1-hydroxycyclohexyl phenyl ketone, α,α-dimethoxy-α-hydroxyacetophenone, a blend of 1-hydroxy-cyclohexyl-phenyl ketone and benzophenone, 2-hydroxy-2-methyl-1-phenylpropane, and mixtures thereof.

The alkylene glycol acrylic monomer and the polyfunctional acrylic monomer may be present in the hard coating composition in a total amount of about 90% to about 99.9% by weight, based on the total solids content of the hard coating composition, and the polymerization initiator may be present in the hard coating composition in an amount of about 0.1% to about 10% by weight, based on the total solids content of the hard coating composition.

The hard coating composition may further include a leveling agent, the leveling agent being included in an amount of about 0.01% to about 10% by weight, based on a total weight of the hard coating composition.

The hard coating layer may have a transmittance of about 90% or more.

### DETAILED DESCRIPTION

Korean Patent Application No. 10-2009-0135677, filed on Dec. 31, 2009, in the Korean Intellectual Property Office, and entitled: “Hard Coating Composition and Laminate Comprising Hard Coat Layer,” is incorporated by reference herein in its entirety.

Example embodiments will now be described more fully hereinafter; however, they may be embodied in different forms and should not be construed as limited to the embodiments set forth herein. Rather, these embodiments are provided so that this disclosure will be thorough and complete, and will fully convey the scope of the invention to those skilled in the art. It will also be understood that when a layer or element is referred to as being “on” another layer or substrate, it can be directly on the other layer or substrate, or intervening layers may also be present. Like reference numerals refer to like elements throughout.

A hard coating composition according to an embodiment may include, e.g., an alkylene glycol acrylic monomer, a polyfunctional acrylic monomer, and a polymerization initiator. The alkylene glycol acrylic monomer may be present in an amount of about 5% to about 69% by weight, based on a total solids content of the composition.

(A) Alkylene Glycol Acrylic Monomer

The alkylene glycol acrylic monomer includes alkylene glycol moieties. The alkylene glycol acrylic monomer may also include (meth)acrylate moieties. The alkylene glycol acrylic monomer may be electrically negative and thus may increase an attractive force between polymer molecules. Accordingly, the alkylene glycol acrylic monomer may impart excellent impact and scratch resistance to a resultant hard coating layer formed using the hard coating composition.

The alkylene glycol acrylic monomer may include from 1 to about 35 alkylene glycol moieties. In an implementation, the alkylene glycol acrylic monomer may include two or more alkylene glycol moieties. For example, the alkylene glycol acrylic monomer may include about 2 to about 15 alkylene glycol moieties, preferably about 3 to about 9 alkylene glycol moieties, more preferably about 3 to about 6 alkylene glycol moieties. Most preferably, the alkylene glycol acrylic monomer may include 2, 3 or 6 alkylene glycol moieties.

Including at least one alkylene glycol moiety in the alkylene glycol acrylic monomer may help ensure sufficient impact strength. Maintaining the number of alkylene glycol moieties in the alkylene glycol acrylic monomer at about 35 or less may help ensure that a resultant hard coating layer exhibits sufficient resistance to various factors, e.g., scratches and chemicals.

It is preferred that the alkylene glycol acrylic monomer include two or more functional groups, e.g., (meth)acrylate moieties. In an implementation, the alkylene glycol acrylic monomer may include about 2 to about 15 (meth)acrylate moieties, preferably about 3 to about 9 (meth)acrylate moieties and more preferably about 3 to about 6 (meth)acrylate moieties. Difunctional, trifunctional or hexafunctional alkylene glycol acrylic monomers are most preferred. The presence of two or more functional groups, e.g., (meth)acrylate moieties, may help ensure that improved pencil hardness, scratch resistance, and chemical resistance are achieved.

In an implementation, the alkylene glycol acrylic monomer may be represented by Formula 1:

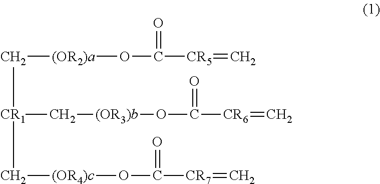

In Formula 1, R₁ may be hydrogen, C₁-C₅ alkyl,

or —CH₂(OR′₁)OC(═O)CR₈═CH₂, R₂, R₃, R₄, and R′₁ may each independently be —CH₂CH₂, —CH₂CH₂CH₂, —CH(CH₃)CH₂, or —CH₂CH₂CH₂CH₂, R₅, R₆, R₇, and R₈ may each independently be H or —CH₃, and a, b, and c may each independently be 0 or positive integers, a sum of a, b, and c being from 1 to about 35.

The C₁-C₅ alkyl may be selected from the group consisting of methyl, ethyl, n-propyl, isopropy, n-butyl, sec-butyl, tert-butyl and n-pentyl.

For example, the alkylene glycol acrylic monomer may include a hydrocarbon or alkyl core with alkylene glycol moieties or groups bonded thereto. In an implementation, the alkyl core may be a C4 alkyl core. The alkylene glycol acrylic monomer may include (meth)acrylate moieties bonded to the alkylene glycol moieties or groups.

In an implementation, R₁ in Formula 1 may be —CH₂CH₃ or —CH₂(OCH₂CH₂)OC(═O)CH═CH₂.

In an implementation, R₂, R₃, R₄, and R′₁ in Formula 1 may each independently be —CH₂CH₂—, —CH₂CH₂CH₂—, or —CH₂CH₂CH₂CH₂—. An ethylene glycol acrylic monomer in which R₂, R₃, R₄, and R′₁ in Formula 1 are all —CH₂CH₂— may be preferred in terms of pencil hardness and scratch resistance when compared to a propylene glycol acrylic monomer, in which, e.g., R₂, R₃, R₄, and R′₁ in Formula 1 are all —CH₂CH₂CH₂—.

In an implementation, a sum of a, b, and c may be from about 1 to about 35, preferably from about 2 to about 15, more preferably from about 3 to about 9 and most preferably from about 3 to about 6.

The alkylene glycol monomer may include, e.g., compounds represented by Formula 1 and mixtures thereof. The alkylene glycol monomer may further include, e.g., one or more alkylene glycol monomers other than the compounds of Formula 1 or a mixture thereof.

The alkylene glycol monomer may be commercially available or be synthesized by using well-known methods. The alkylene glycol monomer may include, e.g., ethoxylated trimethylol propane triacrylate (A-TMPT-3EO or A-TMPT-6EO), ethoxylated pentaerythritol tetraacrylate (ATM-4E), propoxylated trimethylol propane triacrylate (A-TMPT-6PO) and mixtures thereof.

As described above, the alkylene glycol monomer may be present in an amount of about 5% to about 69% by weight, based on the total solids content of the composition. In an implementation, the alkylene glycol monomer may be present in an amount of about 10% to about 68% by weight, preferably about 12% to about 67%, more preferably about 15% to about 65% and most preferably about 16% to about 64%, based on the total solids content of the composition.

Maintaining the amount of the alkylene glycol monomer at about 5% to about 69% by weight may help ensure that improved impact resistance and good scratch resistance are exhibited in the resultant hard coating layer.

In an implementation, the total solids content may consist of a weight of the alkylene glycol acrylic monomer, the polyfunctional acrylic monomer, and the polymerization initiator.

(B) Polyfunctional Acrylic Monomer

The polyfunctional acrylic monomer may increase strength of a hard coating layer formed using the hard coating composition, thereby resulting in improved pencil hardness and scratch resistance. The polyfunctional acrylic monomer may act as a diluent that lowers a viscosity of the hard coating composition. The term “polyfunctional” means that two or more functional groups are present. For example, the polyfunctional acrylic monomer may include difunctional acrylic monomers, trifunctional acrylic monomers, hexafunctional acrylic monomers, and/or mixtures thereof.

The polyfunctional acrylic monomer may be commercially available or be synthesized by using well-known methods.

The polyfunctional acrylic monomer may include, e.g., dipentaerythritol hexaacrylate (DPHA), pentaerythritol triacrylate (PETA), tris(2-hydroxyethyl)isocyanurate triacrylate (THEIC), trimethylol propane triacrylate (TMPTA), hexanediol diacrylate (HDDA), dicyclodecanedimethanol diacrylate (DCPA), and/or mixtures thereof.

The polyfunctional acrylic monomer and the alkylene glycol acrylic monomer together may be present in a total amount of about 90% to 99.9% by weight, based on the total solids content of the composition. In an implementation, the polyfunctional acrylic monomer and the alkylene glycol acrylic monomer together may be present in a total amount of about 90% to 98% by weight, preferably about 90% to 97% by weight based on the total solids content of the composition.

Maintaining the amount of the polyfunctional acrylic monomer and the alkylene glycol acrylic monomer at about 90% to 99.9% by weight may help ensure that curing retardation resulting from oxygen inhibition can be prevented, thereby preventing deterioration of pencil hardness and scratch resistance. In addition, an appropriate viscosity may be maintained to thereby prevent deterioration in flowability of the coating composition, making it possible to form a uniform coating. In an implementation, the polyfunctional acrylic monomer and the alkylene glycol acrylic monomer together may be present in a total amount of about 90% to 96% by weight, based on the total solids content of the composition.

(C) Polymerization Initiator

The polymerization initiator may include any one of those commonly used in UV curable compositions. Examples of polymerization initiators suitable for use in the hard coating composition may include, but are not limited to: benzophenones, including 1-hydroxycyclohexyl phenyl ketone (Irgacure-184), α,α-dimethoxy-α-hydroxyacetophenone (Darocure 1173) and a blend of 1-hydroxy-cyclohexyl-phenyl ketone and benzophenone; and 2-hydroxy-2-methyl-1-phenylpropane. These polymerization initiators may be used alone or as a mixture thereof.

The polymerization initiator may be present in an amount of about 0.1% to about 10% by weight, based on the total solids content of the composition. In an implementation, the polymerization initiator may be present in an amount of about 1% to about 10% by weight, preferably about 2% to 10%, more preferably about 4% to about 10%, and most preferably about 4.5% to about 8% based on the total solids content of the composition.

Maintaining the amount of the polymerization initiator at about 0.1% to about 10% by weight may help ensure that sufficient curing of the hard coating layer formed using the hard coating composition is possible and residual polymerization initiator, which is an impurity deteriorating the hardness of the coat layer, may be eliminated.

In an implementation, the hard coating composition may further include an organic solvent, an additive, or a mixture thereof.

(D) Organic Solvent

Non-limiting examples of the organic solvent may include: alcohols such as isopropanol (IPA), n-propanol (NPA), 2-methoxyethanol (MCS), etc.; and acetates such as ethyl acetate, butyl acetate, etc. The organic solvent may be used alone or as a mixture thereof.

Use of a mixture of alcohols may help ensure sufficient dispersibility. Thus, use of a mixture of two or more solvents including, e.g., the examples described above, is preferred in terms of dispersibility.

The organic solvent is preferably present in an amount such that the solids content of the hard coating composition upon flow coating is about 10% to about 69% by weight. In an implementation, the organic solvent may be present in an amount such that the solids content of the hard coating composition upon flow coating is preferably about 20% to about 67% by weight, more preferably about 30% to about 55% by weight, most preferably about 33% to 45% by weight.

However, in an implementation, the viscosity of the composition may be adjusted depending on the polymerizability of the acrylic monomers, which may thus avoid any need for addition of an organic solvent.

(E) Additive

The hard coating composition may further include one or more additives. Examples of additives suitable for use in the hard coating composition may include, but are not limited to, leveling agents, UV absorbers, and/or surfactants.

For example, the hard coating composition may include a surface leveling agent as the additive. The surface leveling agent may prevent deterioration of leveling of a coating surface caused by impurities present on the coating surface and may also improve wettability of the hard coating composition. The surface leveling agent may be present in an amount of about 0.01% to about 10% by weight, based on a total weight of the hard coating composition. In an implementation, the surface leveling agent may be present in an amount of about 0.05% to about 5% by weight, preferably about 0.07% to about 3% by weight, and more preferably about 0.09% to about 1% by weight.

The embodiments also provide a laminate including a substrate and the hard coating composition coated on the substrate. The substrate may include, e.g., transparent substrates including plastic sheets and panels containing polycarbonate (PC) and polymethylmethacrylate (PMMA) resins, but are not limited thereto. For example, the substrate may include an impact resistant PMMA sheet containing rubber particles dispersed in the resin.

The hard coating composition may be coated on the substrate by known, suitable techniques, e.g., flow coating. When using flow coating, a transparent plastic substrate may be positioned in an upright state and the coating composition may be applied to upper ends of both sides of the substrate through nozzles while moving the substrate along a conveyor. Thereafter, the coated composition may be dried under an infrared lamp at about 50° C. to about 100° C., preferably 60° C. to about 80° C. for about 1 min to about 10 min, preferably about 2 min to about 5 min, UV cured under a mercury lamp at about 300 mJ/cm² to about 900 mJ/cm² (UV A), preferably about 500 mJ/cm² to about 800 mJ/cm² (UV A).

A thickness of the hard coating composition coated on the substrate is not limited. For example, the hard coating composition may be coated to a thickness of about 1 μm to about 40 μm.

The hard coating composition may form a transparent hard coating layer. The hard coating composition may be coated on surfaces of transparent substrates, e.g., polycarbonate and polymethacrylate panels, covering surfaces of plastic liquid crystal displays, flat panel display liquid crystal screens, computer screens, and/or safety glasses to exhibit good resistance to scratches, impact, and organic solvents.

### EXAMPLES

The configuration and operation of the embodiments will be described in more detail with reference to Examples 1-9, Comparative Examples 1-4, and Test Example 1. It should be noted that the following Examples are given by way of illustration and should not be construed to limit the scope of the invention in any sense. Moreover, the Comparative Examples are set forth to highlight certain characteristics of certain embodiments and are not to be construed as either limiting the scope of the invention as exemplified in the Examples or as necessarily always being outside the scope of the invention in every respect. Disclosures that are not included herein will be readily recognized and appreciated by those skilled in the art, and thus explanation thereof is omitted.

In the following Examples and Comparative Examples, unless otherwise indicated, all parts and percentages are by weight. The above-mentioned components were used to prepare hard coating compositions in Examples 1-9 and Comparative Examples 1-4. The contents (parts by weight) of the components are shown in Tables 1 and 2.

### Example 1

3 parts by weight of (C) Irgacure 184 (Ciba Specialty Chemical Inc.) as a polymerization initiator was mixed with 26.0 parts by weight of (D1) 2-methoxyethanol (MCS) as an organic solvent. 10 parts by weight of (B1) dipentaerythritol hexaacrylate (DPHA) (NOPCOMER 4612, Sanopco Co., Ltd.) and 10 parts by weight of (B2) pentaerythritol triacrylate (PETA) (M430, Miwon Commercial Co., Ltd., Korea) as polyfunctional acrylic monomers were added to the mixture. Then, 11 parts by weight of (A1) ethoxylated trimethylol propane triacrylate (TMPT3EOA, EO3 mol) (A-TMPT-3EO, Shin-Nakamura Chemical Co., Ltd.) of Formula 2, below, was added as an alkylene glycol acrylic monomer.

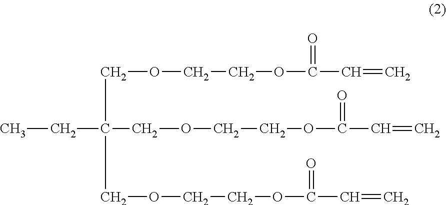

After the resulting mixture was stirred, 39.8 parts by weight of (D2) isopropyl alcohol (IPA) as an organic solvent was added, followed by stirring. The addition of 0.2 parts by weight of (E) polyether-modified polydimethylsiloxane (BYK 306, BYK) as a leveling agent afforded a UV-curable hard coating composition as a solution.

### Example 2

A hard coating composition was prepared in the same manner as in Example 1, except that (A2) ethoxylated trimethylol propane triacrylate (TMPT6EOA, EO6 mol) (A-TMPT-6EO, Shin-Nakamura Chemical Co., Ltd.) of Formula 3, below, was used as an ethylene glycol acrylic monomer instead of (A1) TMPT3EOA, EO3 mol.

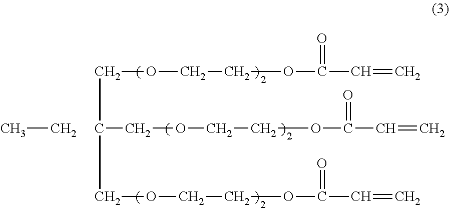

### Example 3

A hard coating composition was prepared in the same manner as in Example 1, except that (A3) ethoxylated pentaerythritol tetraacrylate (ATM-4E, EO4 mol) (Shin-Nakamura Chemical Co., Ltd.) of Formula 4, below, was used as an ethylene glycol acrylic monomer instead of (A1) TMPT3EOA, EO3 mol.

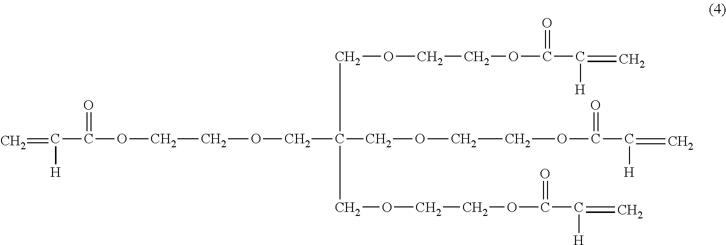

### Example 4

A hard coating composition was prepared in the same manner as in Example 1, except that (A4) propoxylated trimethylol propane triacrylate (A-TMPT-6PO, Shin-Nakamura Chemical Co., Ltd.) of Formula 5, below, was used as an ethylene glycol acrylic monomer instead of (A1) TMPT3EOA, EO3 mol.

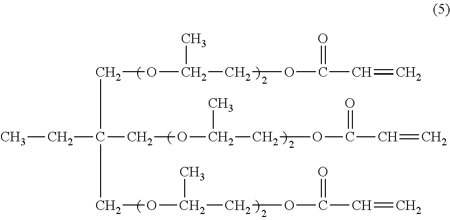

### Example 5

3 parts by weight of the polymerization initiator (C) Irgacure 184 was mixed with 26.0 parts by weight of the organic solvent (D1) MCS. 12.5 parts by weight of the polyfunctional acrylic monomer (B1) DPHA and 12.5 parts by weight of the polyfunctional acrylic monomer (B2) PETA were added to the mixture. Then, 6 parts by weight of the alkylene glycol acrylic monomer (A1) TMPT3EOA, EO3 mol was added thereto. After the resulting mixture was stirred, 39.8 parts by weight of the organic solvent (D2) IPA was added, followed by stirring. Addition and mixing of 0.2 parts by weight of the leveling agent (E) polyether-modified polydimethylsiloxane afforded a UV-curable hard coating composition as a solution.

### Example 6

A hard coating composition was prepared in the same manner as in Example 5, except that the ethylene glycol acrylic monomer (A2) TMPT6EOA, EO6 mol was used instead of (A1) TMPT3EOA, EO3 mol.

### Example 7

A hard coating composition was prepared in the same manner as in Example 5, except that the ethylene glycol acrylic monomer (A3) ATM-4E, EO4 mol was used instead of (A1) TMPT3EOA, EO3 mol.

### Example 8

3 parts by weight of the polymerization initiator (C) Irgacure 184 was mixed with 30.0 parts by weight of the organic solvent (D1) MCS. 5.0 parts by weight of the polyfunctional acrylic monomer (B1) DPHA and 15.0 parts by weight of the polyfunctional acrylic monomer (B2) PETA were added to the mixture. Then, 20.0 parts by weight of the alkylene glycol acrylic monomer (A1) TMPT3EOA, EO3 mol was added thereto. After the resulting mixture was stirred, 26.8 parts by weight of the organic solvent (D2) IPA was added, followed by stirring. Addition and mixing of 0.2 parts by weight of the leveling agent (E) polyether-modified polydimethylsiloxane afforded a UV-curable hard coating composition as a solution.

### Example 9

3 parts by weight of the polymerization initiator (C) Irgacure 184 was mixed with 20.0 parts by weight of the organic solvent (D1) MCS. 5.0 parts by weight of the polyfunctional acrylic monomer (B1) DPHA and 15.0 parts by weight of the polyfunctional acrylic monomer (B2) PETA were added to the mixture. Then, 40.0 parts by weight of the alkylene glycol acrylic monomer (A1) TMPT3EOA, EO3 mol was added thereto. After the resulting mixture was stirred, 16.8 parts by weight of the organic solvent (D2) IPA was added, followed by stirring. Addition and mixing of 0.2 parts by weight of the leveling agent (E) polyether-modified polydimethylsiloxane afforded a UV-curable hard coating composition as a solution.

### Comparative Example 1

A hard coating composition was prepared in the same manner as in Example 1, except that an alkylene glycol acrylic monomer was not used. In Comparative Example 1, trimethylol propane triacrylate (A-TMPT, Shin-Nakamura Chemical Co., Ltd.) of Formula 6, below, was used instead of (A1) TMPT3EOA, EO3 mol.

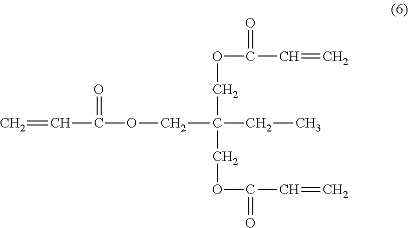

### Comparative Example 2

A hard coating composition was prepared in the same manner as in Example 1, except that isobornyl acrylate (IBOA, SK Cytec Co., Ltd., Korea) was used as a monofunctional acrylic monomer instead of (A1) TMPT3EOA, EO3 mol.

### Comparative Example 3

A hard coating composition was prepared in the same manner as in Example 1, except that urethane acrylate (EB284, SK Cytec Co., Ltd., Korea) was used instead of (A1) TMPT3EOA, EO3 mol.

### Comparative Example 4

3 parts by weight of the polymerization initiator (C) Irgacure 184 was mixed with 10.8 parts by weight of the organic solvent (D1) MCS. 5.0 parts by weight of the polyfunctional acrylic monomer (B1) DPHA was added to the mixture. Then, 75.0 parts by weight of the alkylene glycol acrylic monomer (A1) TMPT3EOA, EO3 mol was added thereto. After the resulting mixture was stirred, 6.0 parts by weight of the organic solvent (D2) IPA was added, followed by stirring. Addition and mixing of 0.2 parts by weight of the leveling agent (E) polyether-modified polydimethylsiloxane afforded a UV-curable hard coating composition as a solution.

### Comparative Example 5

3 parts by weight of the polymerization initiator (C) Irgacure 184 was mixed with 26 parts by weight of the organic solvent (D1) MCS. 20 parts by weight of the polyfunctional acrylic monomer (B1) DPHA and 20 parts by weight of the polyfunctional acrylic monomer (B2) PETA were added to the mixture. Then, 2 parts by weight of the alkylene glycol acrylic monomer (A1) TMPT3EOA, EO3 mol was added thereto. After the resulting mixture was stirred, 28.8 parts by weight of the organic solvent (D2) IPA was added, followed by stirring. Addition and mixing of 0.2 parts by weight of the leveling agent (E) polyether-modified polydimethylsiloxane afforded a UV-curable hard coating composition as a solution.

### ANALYSIS

TABLE 1

| Compo- | | Examples | | | | | | | | |
|---|---|---|---|---|---|---|---|---|---|---|
| sition | | 1 | 2 | 3 | 4 | 5 | 6 | 7 | 8 | 9 |
| A | A1 | 11 | — | — | — | 6 | — | — | 20 | 40 |
| | A2 | — | 11 | — | — | — | 6 | — | — | — |
| | A3 | — | — | 11 | — | — | — | 6 | — | — |
| | A4 | — | — | — | 11 | — | — | — | — | — |
| a | a1 | — | — | — | — | — | — | — | — | — |
| | a2 | — | — | — | — | — | — | — | — | — |
| | a3 | — | — | — | — | — | — | — | — | — |
| B | B1 | 10 | 10 | 10 | 10 | 12.5 | 12.5 | 12.5 | 5 | 5 |
| | B2 | 10 | 10 | 10 | 10 | 12.5 | 12.5 | 12.5 | 15 | 15 |
| C | C | 3 | 3 | 3 | 3 | 3 | 3 | 3 | 3 | 3 |
| D | D1 | 26 | 26 | 26 | 26 | 26 | 26 | 26 | 30 | 20 |
| | D2 | 39.8 | 39.8 | 39.8 | 39.8 | 39.8 | 39.8 | 39.8 | 26.8 | 16.8 |
| E | E | 0.2 | 0.2 | 0.2 | 0.2 | 0.2 | 0.2 | 0.2 | 0.2 | 0.2 |

| | | | | | | | | | |
|---|---|---|---|---|---|---|---|---|---|
| Solids | 34 | 34 | 34 | 34 | 34 | 34 | 34 | 43 | 63 |
| content | | | | | | | | | |

Note:
In Table 1, solids content means % by weight of the alkylene glycol acrylic monomer, the polyfunctional acrylic monomer, and the polymerization initiator, based on the total weight of the composition.

TABLE 2

| | Comparative Examples | | | | |
|---|---|---|---|---|---|
| Composition | 1 | 2 | 3 | 4 | 5 |

| | | | | | | |
|---|---|---|---|---|---|---|
| A | A1 | — | — | — | 75 | 2 |
| | A2 | — | — | — | — | — |
| | A3 | — | — | — | — | — |
| | A4 | — | — | — | — | — |
| a | a1 | 11 | — | — | — | — |
| | a2 | — | 11 | — | — | — |
| | a3 | — | | 11 | — | — |
| B | B1 | 10 | 10 | 10 | 5 | 20 |
| | B2 | 10 | 10 | 10 | — | 20 |
| C | C | 3 | 3 | 3 | 3 | 3 |
| D | D1 | 26 | 26 | 26 | 10.8 | 26 |
| | D2 | 39.8 | 39.8 | 39.8 | 6.0 | 28.8 |
| E | E | 0.2 | 0.2 | 0.2 | 0.2 | 0.2 |

| | | | | | |
|---|---|---|---|---|---|
| Solids | 34 | 34 | 34 | 83 | 45 |
| content | | | | | |

Note:
In Table 2, solids content means % by weight of the alkylene glycol acrylic monomer, the polyfunctional acrylic monomer, and the polymerization initiator based on the total weight of the composition.

### Test Example 1

### Evaluation of Hard Coating Sheets

1-1: Formation of Coatings

1.0 mm thick impact resistant PMMA sheets (COMOGLASS HI, KURARAY) were used as substrates. A surface of each of the sheets was washed with isopropyl alcohol. Each of the coating compositions prepared in Examples 1-9 and Comparative Examples 1-5 was sprayed on the sheet in a vertical direction through a nozzle (12 mm) by flow coating. The coating was performed at a temperature of 25° C. while maintaining humidity at 50%. The coated sheet was dried in an infrared drier at 60° C. for 3 min. The dried sheet was irradiated using a UV lamp at a dose of 500 mJ/cm² at 65° C. for 2 sec to cure the hard coating composition and form a hard coating layer with a thickness of 8 to 13 μm on the sheet.

1-2: Evaluation Methods

The sheets coated with the hard coating layer using the hard coating compositions prepared in Examples 1-9 and Comparative Examples 1-5 were evaluated for pencil hardness, transmittance, impact resistance, appearance, and scratch resistance. The results are shown in Tables 3 and 4. For evaluation, specimens having a size of 200 mm×250 mm were prepared.

1) Pencil hardness was measured according to ASTM D3502 (pencil hardness tester).

2) Transmittance was measured by UV-vis spectroscopy in a 550 nm wavelength (DARSA PRO-5000 SYSTEM).

3) Impact resistance was evaluated by dropping a steel ball weighing 36 g from a height of 30 cm onto the specimen and observing whether the specimen was broken. Specifically, after a steel ball weighing 36 g was dropped from a height of 30 cm onto the specimen positioned on a 70 mm×70 mm×50 mm jig, the specimen was observed to detect breakage. “Good” means that breakage is not observed in the specimen. “Broken” means that breakage is observed in the specimen.

4) Appearance was evaluated by visual observation under a triple wavelength lamp. “Good” means that orange feel is not observed in the specimen. “Bad” means that orange feel is observed in the specimen.

5) Scratch resistance was evaluated by repetitively (15 times) abrading the specimen with steel wool #0000 under a load of 100 g and observing whether scratches were formed on the specimen. “Good” means that scratches are not observed in the specimen. “Scratched” means that scratches are observed in the specimen.

TABLE 3

| | Examples | | | | | | | | |
|---|---|---|---|---|---|---|---|---|---|
| | 1 | 2 | 3 | 4 | 5 | 6 | 7 | 8 | 9 |
| Pencil | 4H | 4H | 4H | 4H | 4H | 4H | 4H | 4H | 4H |
| hardness | | | | | | | | | |
| Scratch | Good | Good | Good | Good | Good | Good | Good | Good | Good |
| resistance | | | | | | | | | |
| Impact | Good | Good | Good | Good | Good | Good | Good | Good | Good |
| strength | | | | | | | | | |
| Transmittance | ≧90% | ≧90% | ≧90% | ≧90% | ≧90% | ≧90% | ≧90% | ≧90% | ≧90% |
| (%) | | | | | | | | | |
| Appearance | Good | Good | Good | Good | Good | Good | Good | Good | Good |

TABLE 4

| | Comparative Examples | | | | |
|---|---|---|---|---|---|
| | 1 | 2 | 3 | 4 | 5 |
| Pencil hardness | 4H | 3H | 3H | 4H | 4H |
| Scratch | Good | Scratched | Scratched | Scratched | Good |
| resistance | | | | | |
| Impact strength | Broken | Good | Good | Good | Broken |
| Transmittance | ≧90% | ≧90% | ≧90% | ≧90% | ≧90% |
| (%) | | | | | |
| Appearance | Good | Good | Bad | Bad | Good |

As shown in Table 3, the hard coating layers formed from the coating compositions of Examples 1 to 9, each of which included the alkylene glycol acrylic monomer, exhibited good appearance, high transmittance and hardness, and improved scratch resistance and impact strength. The coating composition of Comparative Example 1 included the acrylic monomer having a structure similar to the structures of the alkylene glycol acrylic monomers used in Examples 1-9, but did not include an alkylene glycol moiety. The coating composition of Comparative Example 2 included a monofunctional acrylate monomer instead of the alkylene glycol acrylic monomers. The coating composition of Comparative Example 3 included a urethane acrylate oligomer instead of the alkylene glycol acrylic monomers. An amount of the alkylene glycol acrylic monomer used in the coating composition of Comparative Example 4 was larger than the amounts of the alkylene glycol acrylic monomers used in the coating compositions of Examples 1-9. An amount of the alkylene glycol acrylic monomer used in the coating composition of Comparative Example 5 was less than the amounts of the alkylene glycol acrylic monomers used in the coating compositions of Examples 1-9. As can be seen from the results in Table 4, the sheet including the hard coating layer formed from the composition of Comparative Example 1 exhibited poor impact strength. The sheets including the hard coating layers formed using the compositions of Comparative Examples 2 and 3 exhibited poor scratch resistance. The sheet including the hard coating layer formed using the composition of Comparative Example 4 exhibited deteriorated scratch resistance and had a poor appearance. The sheet including the hard coating layer formed using the composition of Comparative Example 5 exhibited deteriorated impact strength.

In general, a hard coating composition for the formation of hard coating layers may include a polymerizable acrylic resin. Impact resistance and flexibility of the hard coating layer may be improved by reducing a number of functional groups of the acrylic resin. However, the reduced number of functional groups may detract from pencil hardness and scratch resistance.

For example, a monofunctional acrylic monomer and a difunctional oligomer may improve the impact resistance and flexibility of the hard coating layer. However, the monomer and oligomer may remain unreacted; and low hardness thereof may detract from pencil hardness and scratch resistance. Further, toxicity of the monofunctional acrylic monomer may also increase a risk of skin diseases in workers handling the monofunctional acrylic monomer.

The embodiments provide a hard coating composition that uses an alkylene glycol acrylic monomer to achieve excellent impact and scratch resistance and high pencil hardness in a resultant hard coating layer.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A hard coating composition, comprising:
an alkylene glycol acrylic monomer;
a polyfunctional acrylic monomer; and
a polymerization initiator, wherein the alkylene glycol acrylic monomer is present in an amount of about 5% to about 69% by weight, based on a total solids content of the hard coating composition.

2. The hard coating composition as claimed in claim 1, wherein the alkylene glycol acrylic monomer includes from 1 to about 35 alkylene glycol moieties.

3. The hard coating composition as claimed in claim 1, wherein the alkylene glycol acrylic monomer includes one or more compounds represented by Formula 1, below: 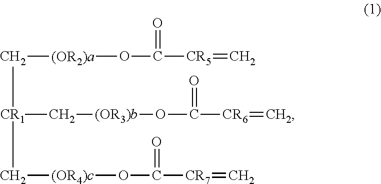
and
in Formula 1:
R₁ is hydrogen, C₁-C₅ alkyl, or —CH₂(OR′₁)OC(═O)CR₈═CH₂,
R₂, R₃, R₄, and R′₁ are each independently —CH₂CH₂—, —CH₂CH₂CH₂—, —CH(CH₃)CH₂—, or —CH₂CH₂CH₂CH₂—,
R₅, R₆, R₇, and R₈ are each independently H or —CH₃, and
a, b, and c are each independently 0 or positive integers, the sum of a, b, and c being 1 to about 35.

4. The hard coating composition as claimed in claim 3, wherein R₂, R₃, R₄, and R′₁ are each —CH₂CH₂—.

5. The hard coating composition as claimed in claim 1, wherein the polyfunctional acrylic monomer includes at least one of dipentaerythritol hexaacrylate (DPHA), pentaerythritol triacrylate (PETA), tris(2-hydroxyethyl)isocyanurate triacrylate (THEIC), trimethylol propane triacrylate (TMPTA), hexanediol diacrylate (HDDA), dicyclodecanedimethanol diacrylate (DCPA), and mixtures thereof.

6. The hard coating composition as claimed in claim 1, wherein the polymerization initiator includes at least one of 1-hydroxycyclohexyl phenyl ketone, α,α-dimethoxy-α-hydroxyacetophenone, a blend of 1-hydroxy-cyclohexyl-phenyl ketone and benzophenone, 2-hydroxy-2-methyl-1-phenylpropane, and mixtures thereof.

7. The hard coating composition as claimed in claim 1, further comprising an organic solvent including at least one of alcohol and acetate.

8. The hard coating composition as claimed in claim 1, wherein:
the alkylene glycol acrylic monomer and the polyfunctional acrylic monomer are present in a total amount of about 90% to about 99.9% by weight, based on the total solids content of the hard coating composition, and
the polymerization initiator is present in an amount of about 0.1% to about 10% by weight, based on the total solids content of the hard coating composition.

9. The hard coating composition as claimed in claim 1, further comprising a leveling agent, the leveling agent being included in an amount of about 0.01% to about 10% by weight, based on a total weight of the hard coating composition.

10. A laminate, comprising:
a substrate; and
a hard coating layer on the substrate, the hard coating layer being formed from the hard coating composition as claimed in claim 1.

11. The laminate as claimed in claim 10, wherein the substrate is a PMMA sheet including rubber particles dispersed therein.

12. The laminate as claimed in claim 10, wherein the hard coating composition is coated to a thickness of about 1 μm to about 40 μm.

13. The laminate as claimed in claim 10, wherein the alkylene glycol acrylic monomer of the hard coating composition includes from 1 to about 35 alkylene glycol moieties.

14. The laminate as claimed in claim 10, wherein the alkylene glycol acrylic monomer of the hard coating composition includes one or more compounds represented by Formula 1, below: 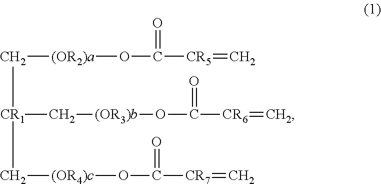
and
in Formula 1:
R₁ is hydrogen, C₁-C₅ alkyl, or —CH₂(OR′₁)OC(═O)CR₈═CH₂,
R₂, R₃, R₄, and R′₁ are each independently —CH₂CH₂—, —CH₂CH₂CH₂—, —CH(CH₃)CH₂, or —CH₂CH₂CH₂CH₂—,
R₅, R₆, R₇, and R₈ are each independently H or —CH₃, and
a, b, and c are each independently 0 or positive integers, the sum of a, b, and c being 1 to about 35.

15. The laminate as claimed in claim 14, wherein R₂, R₃, R₄, and R′₁ are each —CH₂CH₂—.

16. The laminate as claimed in claim 10, wherein the polyfunctional acrylic monomer of the hard coating composition includes at least one of dipentaerythritol hexaacrylate (DPHA), pentaerythritol triacrylate (PETA), tris(2-hydroxyethyl)isocyanurate triacrylate (THEIC), trimethylol propane triacrylate (TMPTA), hexanediol diacrylate (HDDA), dicyclodecanedimethanol diacrylate (DCPA), and mixtures thereof.

17. The laminate as claimed in claim 10, wherein the polymerization initiator of the hard coating composition includes at least one of 1-hydroxycyclohexyl phenyl ketone, α,α-dimethoxy-α-hydroxyacetophenone, a blend of 1-hydroxy-cyclohexyl-phenyl ketone and benzophenone, 2-hydroxy-2-methyl-1-phenylpropane, and mixtures thereof.

18. The laminate as claimed in claim 10, wherein:
the alkylene glycol acrylic monomer and the polyfunctional acrylic monomer are present in the hard coating composition in a total amount of about 90% to about 99.9% by weight, based on the total solids content of the hard coating composition, and
the polymerization initiator is present in the hard coating composition in an amount of about 0.1% to about 10% by weight, based on the total solids content of the hard coating composition.

19. The laminate as claimed in claim 10, wherein the hard coating composition further includes a leveling agent, the leveling agent being included in an amount of about 0.01% to about 10% by weight, based on a total weight of the hard coating composition.

20. The laminate as claimed in claim 10, wherein the hard coating layer has a transmittance of about 90% or more.
